(19) United States
(12) Patent Application Publication
(10) Pub. No.: US 2023/0348695 A1
(43) Pub. Date: Nov. 2, 2023

(54) Composite Material and Fastening Nut Made of Composite Material

(71) Applicant: Illinois Tool Works Inc., Glenview, IL (US)

(72) Inventor: YuJen LO, Kaohsiung (TW)

(21) Appl. No.: 18/022,010

(22) PCT Filed: Aug. 9, 2021
(86) PCT No.: PCT/US2021/045189

§ 371 Date: Feb. 17, 2023

(30) Foreign Application Priority Data
Aug. 18, 2020 (CN) 202010830918.4
Jul. 21, 2021 (CN) 202110824099.7

(51) Int. Cl. C08K 7/06; F16B 37/00; C08G 65/40; C08K 7/14

(52) U.S. Cl. CPC C08K 7/06; F16B 37/00; C08G 65/4012; C08K 7/14; C08K 2201/014

(57) ABSTRACT

The present application discloses a composite material and a fastening nut made therefrom, the composite material comprising: a polyether ether ketone resin, glass fibre and carbon fibre. The fastening nut is used to connect a CPU processor to a motherboard. The present application takes into account the environment of use of the fastening nut and the associated demands in terms of performance and cost of the fastening nut, and uses both glass fibre and carbon fibre to modify polyether ether ketone resin, such that the composite material obtained has excellent notch impact strength, excellent insulating properties, a suitable tensile modulus and a reduced cost, so that the fastening nut made from the composite material has excellent torque resistance, suitable resistance to stretching deformation and excellent resistance to high-temperature attenuation, and also has good product stability and a low production cost, so is especially suitable for connecting a CPU processor to a motherboard.

### RELATED APPLICATIONS

The present application claims the benefit of Chinese Patent Application No. 202010830918.4, filed Aug. 18, 2020, and to Chinese Patent Application No. 202110824099.7, filed Jul. 21, 2021. The entireties of Chinese Patent Application No. 202010830918.4 and Chinese Patent Application No. 202110824099.7 are incorporated herein by reference.

### FIELD OF THE DISCLOSURE

The present application relates to the field of composite materials and fasteners, in particular to a polyether ether ketone resin composite material and a fastening nut made therefrom.

### BACKGROUND

Inside a computer, a central processing unit (CPU processor) needs to be mounted on a motherboard. The CPU processor has multiple pins, and after the CPU processor has been mounted to the motherboard, it is necessary to ensure not only that these pins cannot be bent by pressing but also that they are in contact with the motherboard, so that the CPU processor can be electrically connected to the motherboard and transfer data. Fasteners such as fastening nuts and fastening bolts are generally used to mount the CPU processor to the motherboard securely.

### SUMMARY

An object of the present application, in a first aspect, is to provide a fastening nut made from a composite material, the composite material comprising: a polyether ether ketone resin, making up 29-98% of the total weight of the composite material; glass fibre, making up 1-70% of the total weight of the composite material; and carbon fibre, making up 1-70% of the total weight of the composite material.

According to the first aspect, the composite material further comprises: an aid, making up 0-10% of the total weight of the composite material.

According to the first aspect, the aid comprises at least one of a dispersant and an antioxidant.

According to the first aspect, the glass fibre makes up 10-20% of the total weight of the composite material; and the carbon fibre makes up 10-20% of the total weight of the composite material.

According to the first aspect, the weight ratio of the glass fibre to the carbon fibre is (2:1)-(1:2).

According to the first aspect, the weight ratio of the glass fibre to the carbon fibre is 1:1.

According to the first aspect, the glass fibre makes up 12-18% of the total weight of the composite material; and the carbon fibre makes up 12-18% of the total weight of the composite material.

According to the first aspect, the glass fibre makes up 14-16% of the total weight of the composite material; and the carbon fibre makes up 14-16% of the total weight of the composite material.

According to the first aspect, the glass fibre makes up 15% of the total weight of the composite material; and the carbon fibre makes up 15% of the total weight of the composite material.

According to the first aspect, the polyether ether ketone resin makes up 67% of the total weight of the composite material.

According to the first aspect, the glass fibre has a length of 3-5 mm, and the carbon fibre has a length of 0.1-40 mm.

According to the first aspect, the glass fibre has a diameter of 10-20 μm, and the carbon fibre has a diameter of 3-8 μm.

According to the first aspect, the fastening nut is used to connect a CPU processor to a motherboard.

According to the first aspect, the fastening nut is configured to securely connect the CPU processor to the motherboard; wherein a spring is provided between the CPU processor and the motherboard.

According to the first aspect, the fastening nut has a breaking torque greater than 32 Lb.In, and a locking force attenuation of less than 18% after 300 hours at 100° C.

An object of the present application, in a second aspect, is to provide a composite material, comprising: a polyether ether ketone resin, making up 29-98% of the total weight of the composite material; glass fibre, making up 1-70% of the total weight of the composite material; and carbon fibre, making up 1-70% of the total weight of the composite material.

According to the second aspect, the composite material further comprises: an aid, making up 0-10% of the total weight of the composite material.

According to the second aspect, the aid comprises at least one of a dispersant and an antioxidant.

According to the second aspect, the glass fibre makes up 10-20% of the total weight of the composite material; and the carbon fibre makes up 10-20% of the total weight of the composite material.

According to the second aspect, the weight ratio of the glass fibre to the carbon fibre is (2:1)-(1:2).

According to the second aspect, the weight ratio of the glass fibre to the carbon fibre is 1:1.

According to the second aspect, the glass fibre makes up 12-18% of the total weight of the composite material; and the carbon fibre makes up 12-18% of the total weight of the composite material.

According to the second aspect, the glass fibre makes up 14-16% of the total weight of the composite material; and the carbon fibre makes up 14-16% of the total weight of the composite material.

According to the second aspect, the glass fibre makes up 15% of the total weight of the composite material; and the carbon fibre makes up 15% of the total weight of the composite material.

According to the second aspect, the polyether ether ketone resin makes up 67% of the total weight of the composite material.

According to the second aspect, the glass fibre has a length of 3-5 mm, and the carbon fibre has a length of 0.1-40 mm.

According to the second aspect, the glass fibre has a diameter of 10-20 μm, and the carbon fibre has a diameter of 3-8 μm.

### BRIEF DESCRIPTION OF THE DRAWINGS

FIG. 1A is a three-dimensional structural drawing of the fastening nut according to an embodiment of the present application.

FIG. 1B is an axial sectional view of FIG. 1A.

FIG. 2A is a structural schematic drawing in which a CPU processor is mounted to a motherboard using the fastening nut shown in FIG. 1A.

FIG. 2B is a side view of FIG. 2A.

FIG. 3 is a structural schematic drawing of a breaking torque testing apparatus for the fastening nut according to the present application.

### DETAILED DESCRIPTION

Various particular embodiments of the present application are described below with reference to the drawings, which form part of this specification. It should be understood that although terms indicating direction, such as “front”, “rear”, “up”, “down”, “left”, “right”, “top”, “bottom”, “inner”, “outer”, etc. are used in the present application to describe various exemplary structural parts and elements thereof, these terms are used here merely to facilitate explanation, and are determined on the basis of the exemplary orientations shown in the drawings. The embodiments disclosed in the present application can be configured in different directions, so these terms indicating direction are merely explanatory and should not be regarded as restrictive.

In the present application, unless stated otherwise, all equipment and raw materials are commercially available or commonly used in the art, and unless stated otherwise, all methods in the embodiments below are conventional methods in the art.

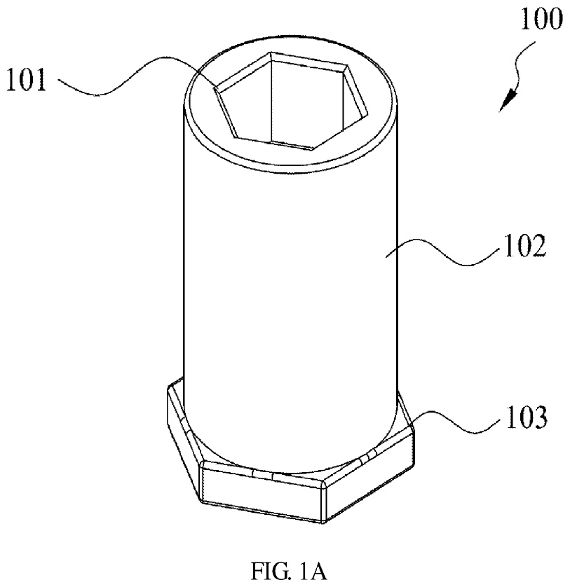

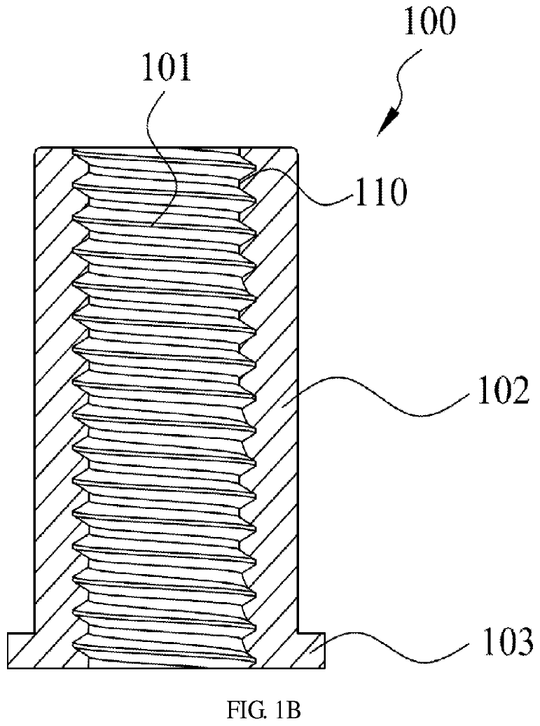

FIGS. 1A and 1B show the structure of a fastening nut 100 according to an embodiment of the present application, wherein FIG. 1A is a three-dimensional structural drawing of the fastening nut 100, and FIG. 1B is an axial sectional view of FIG. 1A. As shown in FIGS. 1A and 1B, the fastening nut 100 substantially has an axially symmetric shape, and comprises a tube part 102 and a base 103, wherein the tube part 102 has a cylindrical shape, and the base 103 is disposed at the bottom of the tube part 102. A threaded hole 101 is provided inside the fastening nut 100, and multiple threads 110 are provided on a hole wall of the threaded hole 101. The fastening nut 100 can be made of a plastic material having a certain strength, in order to avoid a situation in which metal fragments are produced by friction when the fastening nut is securely connected to a fastening bolt, and thus avoid compromising the stability of electrical connection between a CPU processor and a motherboard.

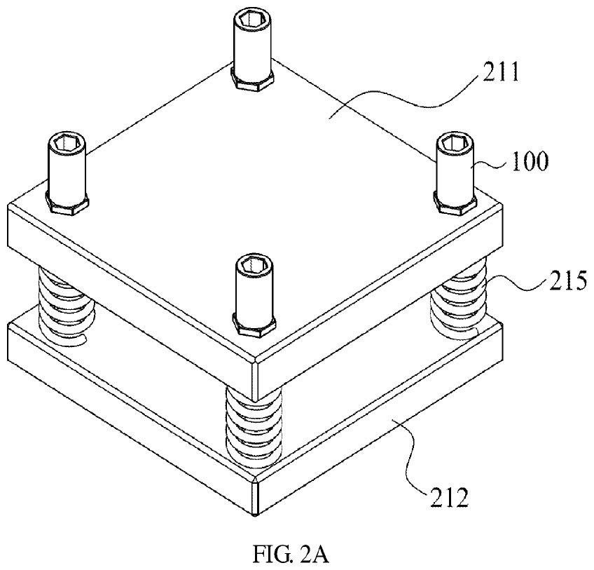

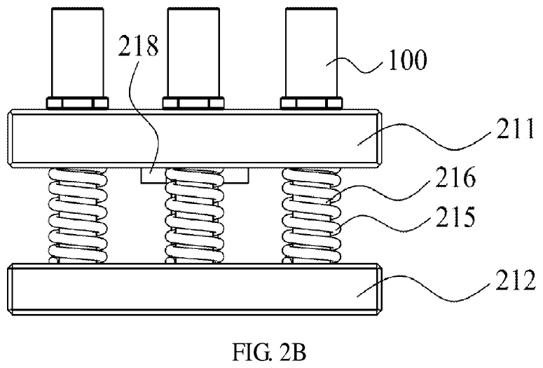

FIGS. 2A and 2B show structural schematic drawings in which a CPU processor 211 is securely mounted to a motherboard 212 using the fastening nut 100 and a bolt 216. Those skilled in the art will understand that although not shown in the drawing, multiple pins protruding towards the motherboard 212 are provided on a lower surface of the CPU processor 211, these pins being configured to be in contact, and electrical connection, with the motherboard 212.

In this embodiment, the CPU processor 211 is securely connected to the motherboard 212 by means of the fastening nut 100 and the bolt 216, and a spring 215 is provided between the CPU processor 211 and the motherboard 212, the spring 215 being fitted round the bolt 216. The CPU processor 211 is securely connected to the motherboard 212 by means of the fastening nut 100 and the bolt 216 such that the pins of the CPU processor 211 are in contact, and electrical connection, with the motherboard 212. At the same time, the spring 215 ensures that the lower surface of the CPU processor 211 is spaced apart from the motherboard 212 by a certain distance, thereby ensuring that the pins of the CPU processor 211 will not be crushed by the motherboard 212. Moreover, when the CPU processor 211 and motherboard 212 are subjected to the action of an external force such as a knock, the spring 215 can perform a cushioning function, to ensure the stability of electrical connection between the CPU processor and motherboard 212.

In one embodiment, there are four each of the fastening nut 100, bolt 216 and spring 215, and these are arranged at four corners of the CPU processor 211 respectively. One end of each bolt 216 is connected to the motherboard 212, and the other end penetrates out to the region above the processor 211 from the region below the CPU processor 211. The springs 215 are fitted round the corresponding bolts 216 between the CPU processor 211 and the motherboard 212. The fastening nuts 100 are screwed onto the bolts 216 from the region above the CPU processor 211 so that the fastening nuts 100 can mesh with the bolts 216, thereby securely connecting the CPU processor 211 to the motherboard 212. As an example, the springs 215 are in a compressed state, and thus provide a certain upward supporting force to the CPU processor 211, and consequently the fastening nuts 100 will also be subjected to an upward resistance force. Thus, because of the springs 215, the fastening nuts 100 need to overcome the continuously sustained upward resistance force to maintain meshing with the bolts 216, in order to maintain the secure connection between the CPU processor 211 and the motherboard 212.

As the bolts 216 are generally made of metal material, they have better mechanical strength and stability than the fastening nuts 100 made of plastic material, hence the strength of connection between the fastening nuts 100 and the bolts 216 is mainly determined by the properties of the fastening nuts 100. The properties of the fastening nuts 100 are mainly determined by the properties of the material used to manufacture the fastening nuts 100. The inventors have discovered that the fastening nuts 100 should have excellent torque resistance. In general, an operator screws the fastening nuts onto the bolts manually. The inventors have discovered that the operator cannot precisely judge a locking position of the locking nuts, so “over-screwing” easily occurs, resulting in slipping or breakage of the threads of the fastening nuts. In order to ensure that when the fastening nuts are screwed onto the bolts, the threads of the fastening nuts will not suffer slipping or breakage, the fastening nuts need sufficiently high torque resistance. Thus, the material used to manufacture the fastening nuts should have good impact strength, so that the fastening nuts have sufficiently high torque resistance. Furthermore, since the fastening nuts have threads, the torque resistance of the fastening nuts is in particular related to the notch impact strength of the material. As discussed below, the material of the present application has good notch impact strength, and so the fastening nuts made from the material of the present application have excellent torque resistance; consequently, when the fastening nuts are screwed onto the bolts, the threads of the fastening nuts will not suffer slipping or breakage.

The inventors have discovered that the fastening nuts 100 should have suitable resistance to stretching deformation. The inventors have discovered that once the fastening nuts have been screwed onto the bolts to connect the CPU processor to the motherboard, the fastening nuts will generally be subjected to stretching forces arising from knocks, etc. However, under the cushioning action of the springs, the stretching force acting on the fastening nuts will generally not be very large, and thus deformation of the fastening nuts due to stretching will not be very large. Thus, the fastening nuts are not required to have very high resistance to stretching deformation; rather, the fastening nuts are merely required to have suitable resistance to stretching deformation. In order to endow the fastening nuts with suitable resistance to stretching deformation, the material used to manufacture the fastening nuts are required to have a suitable tensile modulus. As discussed in detail below, the material of the present application has a suitable tensile modulus, so can endow the fastening nuts with suitable resistance to stretching deformation.

The inventors have also discovered that the fastening nuts 100 should have excellent resistance to high-temperature attenuation. It is beneficial for the fastening nuts to have excellent attenuation resistance at high temperatures, because the actual operating temperature of the CPU processor is quite high (and might reach about 100° C.). Excellent resistance to attenuation at high temperatures enables the fastening nuts to maintain a good locking force at high temperatures for a long period of time when used to fasten the CPU processor to the motherboard, and thereby ensures the long-term stability of electrical connection between the CPU processor and motherboard. As discussed below, the fastening nuts of the present application have excellent resistance to attenuation at high temperatures.

To suit industrial production applications, it is also desired that the fastening nuts should have a low production cost, and stable product quality.

The present application provides a fastening nut with excellent properties. The fastening nut of the present application is made of a composite material. The composite material of the present application comprises, as proportions of the total weight of the composite material, 1-70% glass fibre, 1-70% carbon fibre and 29-98% polyether ether ketone resin.

In some embodiments, the glass fibre and carbon fibre each make up 10-20% of the total weight of the composite material. In some embodiments, the weight ratio of glass fibre to carbon fibre is (2:1)-(1:2). For example, the weight ratio of glass fibre to carbon fibre is 2:1, 1:1 or 1:2. In some embodiments, the glass fibre and carbon fibre each make up 12-18% of the total weight of the composite material. In some embodiments, the glass fibre and carbon fibre each make up 14-16% of the total weight of the composite material. For example, the glass fibre and carbon fibre each make up 15% of the total weight of the composite material. In some embodiments, the carbon fibre length is 0.1-40 mm, and the carbon fibre diameter is 3-8 μm. In some embodiments, the glass fibre length is 3-5 mm, and the glass fibre diameter is 10-20 μm.

In some embodiments, the composite material further comprises an aid making up 0-10% of the total weight of the composite material, wherein the aid may comprise at least one of a dispersant and an antioxidant. Depending on different environmental requirements, other types of aid may also be added to the composite material. Dispersants may include, but are not limited to, fatty acid types, fatty acid amide and ester types, metallic soap types and low-grade wax types; antioxidants may include, but are not limited to, hindered phenol types, hindered amine types, phosphorous acid ester types, thiol types and thiodipropionate types, such as 1010, 1076, 168, etc.

The composite material of the present application has excellent notch impact strength and a suitable tensile modulus, and can endow the fastening nut with excellent torque resistance, excellent resistance to attenuation at high temperatures, stable product properties and suitable resistance to stretching deformation, while also reducing the use of carbon fibre and lowering costs. For these reasons, fastening nuts made from the composite material of the present application are especially suitable for securely connecting a CPU processor to a motherboard.

### Embodiment

Beneficial effects of the present application are illustrated below, taking as examples five types of composite material and three types of fastening nut made from three of these types 30 of composite material. It must be explained that in other embodiments of the present application, the contents of the components of the composite material of the present application can also be other proportions within the abovementioned ranges.

### Composite Material

The polyether ether ketone resin used in the embodiments and comparative embodiments of the present application is from an ordinary commercial source.

The carbon fibre used in the embodiments and comparative embodiments of the present application has a length of 3 mm and a diameter of 5 μm.

The glass fibre used in the embodiments and comparative embodiments of the present application has a length of 5 mm and a diameter of 10 μm.

The aid used in the embodiments and comparative embodiments of the present application is an auxiliary additive commonly used in the art, e.g. a dispersant or an antioxidant, etc.

In the embodiments and comparative embodiments of the present application listed in the table below, the composite materials in each of the embodiments have the same polyether ether ketone resin content, the same type of aid, and the same aid content. Moreover, under the same test conditions, three test samples are taken for testing from each of the composite materials of embodiments 1-3, comparative embodiment 1 and comparative embodiment 2 of the present application. Table 1 shows the components and average values of test results for embodiments 1-3, comparative embodiment 1 and comparative embodiment 2 of the present application.

TABLE 1
Composite materials of embodiments and comparative embodiments of the present
application and results of testing of properties thereof

| | Embodiment 1 | Embodiment 2 | Embodiment 3 | | |
|---|---|---|---|---|---|
| | of present | of present | of present | Comparative | Comparative |
| | application | application | application | embodiment 1 | embodiment 2 |
| Polyether | 67% | 67% | 67% | 67% | 67% |
| ether ketone | | | | | |
| resin | | | | | |
| Carbon fibre | 15% | 10% | 20% | / | 30% |
| Glass fibre | 15% | 20% | 10% | 30% | / |
| Aid | 3% | 3% | 3% | 3% | 3% |
| Tested | | | | | |
| properties | | | | | |
| Tensile | 16.5 | 15 | 18 | 11.5 | 23 |
| modulus/ | | | | | |
| GPa | | | | | |
| (test | | | | | |
| standard: | | | | | |
| ISO 527) | | | | | |
| Impact | 12 | 12 | 10.5 | 12 | 9 |
| strength, | | | | | |
| notch, 23° C./ | | | | | |
| KJ/m² | | | | | |
| (test | | | | | |
| standard: | | | | | |
| ISO 180) | | | | | |

It can be seen from Table 1 that in the composite material of comparative embodiment 2, the polyether ether ketone resin is modified using carbon fibre alone. Although the composite material obtained has a good tensile modulus, the impact strength with a notch is not good. In addition, a large amount of carbon fibre is used, resulting in an excessively high cost, which is not favourable for industrial production applications.

In the composite material of comparative embodiment 1, the polyether ether ketone resin is modified using glass fibre alone. Although glass fibre has a low cost and is able to meet the requirements of industrial applications, and the composite material obtained has good impact strength with a notch, the tensile modulus of the composite material is too low.

In the composite materials of embodiments 1-3 of the present application, the polyether ether ketone resin is modified using both glass fibre and carbon fibre. The composite materials of embodiments 1-3 of the present application have a reduced carbon fibre content, enabling a significant cost saving. Moreover, due to the synergistic action of glass fibre and carbon fibre, as shown in Table 1, the composite materials of embodiments 1-3 of the present application have substantially the same impact strength as the composite material of comparative embodiment 1 which had better notch impact strength, and can thus endow the fastening nut with excellent torque resistance. Furthermore, the composite materials of embodiments 1-3 of the present application have a good tensile modulus, higher than that of comparative embodiment 1, and sufficient to endow the fastening nut with suitable resistance to stretching deformation.

### Fastening Nut

The composite materials of embodiment 1, comparative embodiment 1 and comparative embodiment 2 of the present application as described above are made into fastening nuts in three embodiments as shown in FIGS. 1A and 1B, using the same moulding process.

Test 1: Breaking Torque Test

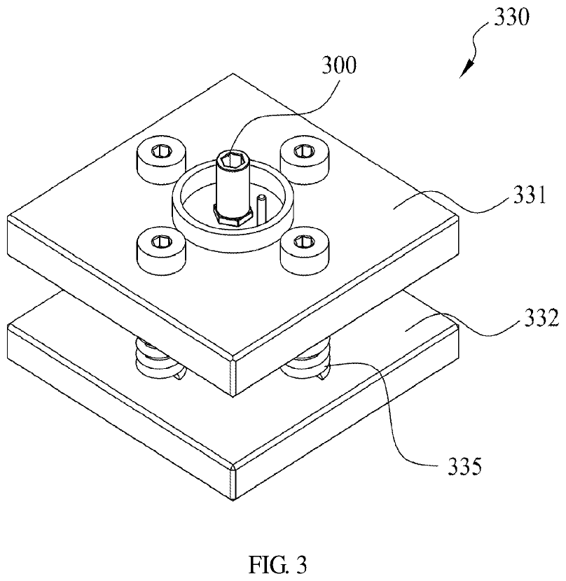

Test apparatus: as shown in FIG. 3, a test apparatus 330 comprises an upper plate 331 (simulating the CPU processor 211 in FIGS. 2A and 2B) and a lower plate 332 (simulating the motherboard 212 in FIGS. 2A and 2B), these two plates being connected by a fastening nut 300 and a bolt. Four load springs 335 are arranged between the upper plate 331 and lower plate 332 (the four load springs 335 simulating the resistance force applied to any one fastening nut 100 by the corresponding spring 215 in FIGS. 2A and 2B), the four load springs 335 being arranged around the bolt and the fastening nut 300.

Test method: A tester screws the fastening nut 300 down onto the bolt. In the process of the fastening nut 300 being screwed down, the load springs 335 are compressed, so as to apply a certain load force (i.e. resistance) to the fastening nut 300. After screwing the fastening nut into contact with the upper plate 331, the tester continues to screw the fastening nut 300 down using a torque wrench, in order to detect the breaking torque when the fastening nut 300 is twisted off the bolt (e.g. the threads inside the fastening nut 300 are destroyed or break).

Test results: The above test is performed separately on 30 each of the fastening nuts made from the composite materials of embodiment 1, comparative embodiment 1 and comparative embodiment 2 of the present application, and the test results are shown in Table 2:

TABLE 2
Test results for breaking torque of fastening nuts in each embodiment

| | Average | Deviation | Minimum | Maximum |
|---|---|---|---|---|
| | value | value | value | value |
| Embodiment 1 of | 32.467 | 1.676 | 28 | 35 |
| present application | | | | |
| (Lb · In) | | | | |
| Comparative | 30.167 | 1.315 | 28 | 33 |
| embodiment 1 | | | | |
| (Lb · In) | | | | |
| Comparative | 32.567 | 2.192 | 28 | 36 |
| embodiment 2 | | | | |
| (Lb · In) | | | | |

It can be seen from Table 2 that the breaking torque of the fastening nut of embodiment 1 of the present application exceeds 32 Lb.In. According to Table 2, in embodiment 1 described in the present application, the breaking torque of the fastening nut reaches 32.467, which is greater than the breaking torque of the fastening nut in comparative embodiment 1, and almost the same as that of the fastening nut in comparative embodiment 2. Thus, the fastening nut in the embodiment of the present application can sustain a larger torque, so has excellent torque resistance.

Furthermore, the breaking torque deviation values of the 30 fastening nuts according to embodiment 1 of the present application are smaller than the breaking torque deviation values of the fastening nuts in comparative embodiment 2. Thus, the fastening nut product of the present application has good stability in terms of quality. This might be due to the synergistic action of carbon fibre and glass fibre, which has the consequence that the dispersion of carbon fibre and glass fibre in polyether ether ketone resin is better than the dispersion of the same total content of carbon fibre in polyether ether ketone resin.

The fastening nut in the embodiment of the present application has excellent torque resistance, and each batch of fastening nut product has more stable quality, i.e. each batch of fastening nuts can have excellent torque resistance.

Test 2: Attenuation Resistance Test

Test method: An upper plate and a lower plate are connected by four sets of fastening nuts and bolts; a tester uses an electronic screwdriver to screw the fastening nuts onto the bolts to a specified torque, and then detects a resistance force between the upper and lower plates, wherein the resistance force reflects a locking force of the fastening nuts. The two connected plates are placed in a 100° C. oven, and the value of the resistance force is recorded once every 1 hour, for a total of 300 hours.

Test results: The above attenuation resistance test is performed separately on the fastening nuts made from the composite materials of embodiment 1, comparative embodiment 1 and comparative embodiment 2 of the present application as described above, and the test results are shown in Table 3:

TABLE 3
Test results for attenuation resistance of fastening
nuts in each embodiment

| | Initial | Final | |
|---|---|---|---|
| | value at | value at | Attenuation |
| | 0 hour | 300 hours | ratio |
| Embodiment 1 of | 259 | 223 | 13.9% |
| present application | | | |
| (LBS) | | | |
| Comparative | 272 | 223 | 18.0% |
| embodiment 1 | | | |
| (LBS) | | | |
| Comparative | 271 | 221 | 18.5% |
| embodiment 2 | | | |
| (LBS) | | | |

It can be seen from Table 3 that for the fastening nuts in comparative embodiment 1 and comparative embodiment 2, the attenuation in locking force is equal to or greater than 18%. Unexpectedly, after a period of time in the high-temperature environment, the attenuation in locking force of the fastening nut in the embodiment of the present application is less than 18%. According to Table 3, after 300 hours at 100° C., the fastening nut in the embodiment described in the present application only has a 13.9% attenuation in locking force; this test result shows that the fastening nut in the embodiment of the present application has excellent resistance to high-temperature attenuation, and can still maintain a good locking force when used at a high temperature for a long period of time, thereby ensuring the long-term stability of electrical connection between the CPU processor and the motherboard.

In summary, the present application takes into account the environment of use of the fastening nut and the associated demands in terms of performance and cost of the fastening nut, and uses both glass fibre and carbon fibre to modify polyether ether ketone resin, such that the composite material obtained has excellent notch impact strength, a suitable tensile modulus and a reduced cost, so that the fastening nut made from the composite material has excellent torque resistance, suitable resistance to stretching deformation and excellent resistance to high-temperature attenuation, and also has good product stability and a low production cost, so is especially suitable for connecting a CPU processor to a motherboard.

Although the present application is described with reference to the particular embodiments shown in the drawings, it should be understood that the composite material and fastening nut of the present application can have several variant forms, without deviating from the spirit, scope and background of the teaching of the present application. Those skilled in the art will also realize that there are different ways of changing the structures in the embodiments disclosed in the present application, all of which fall within the spirit and scope of the present application and claims.

1-20. (canceled)

21. A fastening nut made from a composite material, the composite material comprising:
a polyether ether ketone resin, making up 29-98% of the total weight of the composite material;
glass fiber, making up 1-70% of the total weight of the composite material; and
carbon fiber, making up 1-70% of the total weight of the composite material.

22. The fastening nut as claimed in claim 21, wherein:
the glass fiber makes up 10-20% of the total weight of the composite material; and
the carbon fiber makes up 10-20% of the total weight of the composite material.

23. The fastening nut as claimed in claim 22, wherein:
the weight ratio of the glass fiber to the carbon fiber is (2:1)-(1:2).

24. The fastening nut as claimed in claim 23, wherein:
the weight ratio of the glass fiber to the carbon fiber is 1:1.

25. The fastening nut as claimed in claim 24, wherein:
the glass fiber makes up 15% of the total weight of the composite material; and
the carbon fiber makes up 15% of the total weight of the composite material.

26. The fastening nut as claimed in claim 25, wherein:
the polyether ether ketone resin makes up 67% of the total weight of the composite material.

27. The fastening nut as claimed in claim 21, wherein:
the glass fiber has a length of 3-5 mm, and the carbon fiber has a length of 0.1-40 mm.

28. The fastening nut as claimed in claim 21, wherein:
the glass fiber has a diameter of 10-20 μm, and the carbon fiber has a diameter of 3-8 μm.

29. The fastening nut as claimed in claim 21, wherein:
the fastening nut is used to connect a CPU processor to a motherboard.

30. The fastening nut as claimed in claim 29, wherein:
the fastening nut is configured to securely connect the CPU processor to the motherboard;
wherein a spring is provided between the CPU processor and the motherboard.

31. The fastening nut as claimed in claim 30, wherein:
the fastening nut has a breaking torque greater than 32 Lb.In, and a locking force attenuation of less than 18% after 300 hours at 100° C.

32. The fastening nut as claimed in claim 31, wherein the composite material further comprises:
an aid, making up 0-10% of the total weight of the composite material.

33. The fastening nut as claimed in claim 32, wherein:
the aid comprises at least one of a dispersant and an antioxidant.

34. A composite material, comprising:
a polyether ether ketone resin, making up 29-98% of the total weight of the composite material;
glass fiber, making up 1-70% of the total weight of the composite material; and
carbon fiber, making up 1-70% of the total weight of the composite material.

35. The composite material as claimed in claim 14, wherein:
the glass fiber makes up 10-20% of the total weight of the composite material; and
the carbon fiber makes up 10-20% of the total weight of the composite material.

36. The composite material as claimed in claim 35, wherein:
the weight ratio of the glass fiber to the carbon fiber is (2:1)-(1:2).

37. The composite material as claimed in claim 36, wherein:
the weight ratio of the glass fiber to the carbon fiber is 1:1.

38. The composite material as claimed in claim 37, wherein:
the glass fiber makes up 15% of the total weight of the composite material; and
the carbon fiber makes up 15% of the total weight of the composite material.

39. The composite material as claimed in claim 34, further comprising:
an aid, making up 0-10% of the total weight of the composite material.

40. The composite material as claimed in claim 39, wherein:
the aid comprises at least one of a dispersant and an antioxidant.
